(19) United States
(12) Patent Application Publication
(10) Pub. No.: US 2022/0288827 A1
(43) Pub. Date: Sep. 15, 2022

(54) LIQUID CRYSTAL FILM FOR THREE-DIMENSIONAL MOLDING, THREE-DIMENSIONAL MOLDED BODY, AND METHOD OF MANUFACTURING THREE-DIMENSIONAL MOLDED BODY

(71) Applicant: FUJIFILM Corporation, Tokyo (JP)

(72) Inventor: Makoto KAMO, Minamiashigara-shi (JP)

(73) Assignee: FUJIFILM Corporation, Tokyo (JP)

(21) Appl. No.: 17/829,841

(22) Filed: Jun. 1, 2022

Related U.S. Application Data
(63) Continuation of application No. PCT/JP2020/044899, filed on Dec. 2, 2020.

(30) Foreign Application Priority Data
Dec. 2, 2019 (JP) 2019-218268
Oct. 9, 2020 (JP) 2020-171125
Dec. 1, 2020 (JP) 2020-199700

(51) Int. Cl. B29C 45/37; B29C 51/10; B29C 51/00; B29C 51/14

(52) U.S. Cl. CPC B29C 45/37; B29C 51/10; B29C 51/002; B29C 51/14; B29L 2031/757

(57) ABSTRACT

According to the present invention, provided are a liquid crystal film for three-dimensional molding from which a three-dimensional molded body which is excellent in reproducibility of image light can be obtained during image light irradiation, a three-dimensional molded body, and a method of manufacturing the three-dimensional molded body. A liquid crystal film for three-dimensional molding includes: a substrate; and a functional layer, the functional layer includes a liquid crystal layer, the liquid crystal layer is made from a liquid crystal composition, and a rubbing haze variation of an outermost surface of the functional layer is 0.80% or less.

### CROSS-REFERENCE TO RELATED APPLICATIONS

This application is a Continuation of PCT International Application No. PCT/JP2020/044899 filed on Dec. 2, 2020, which claims priority under 35 U.S.C. § 119(a) to Japanese Patent Application No. 2019-218268 filed on Dec. 2, 2019, Japanese Patent Application No. 2020-171125 filed on Oct. 9, 2020 and Japanese Patent Application No. 2020-199700 filed on Dec. 1, 2020. The above application is hereby expressly incorporated by reference, in its entirety, into the present application.

### BACKGROUND OF THE INVENTION

### 1. Field of the Invention

The present invention relates to a liquid crystal film for three-dimensional molding, a three-dimensional molded body, and a method of manufacturing the three-dimensional molded body.

### 2. Description of the Related Art

A molded body (decorative molded body) decorated by laminating a decorative sheet on a surface of the molded body is used for building members, vehicle interior members, and the like. As a decorative sheet used for a decorative molded body, a sheet having a functional layer provided on a substrate thereof is usually used for the purpose of imparting a visible design (for example, JP2004-322501A). Examples of the method using such a decorative sheet include an insert molding method in which a decorative sheet is previously molded in a three-dimensional shape using a vacuum forming mold (premolding), the premolded sheet is inserted into an injection mold, and a fluidized resin is injected into the mold to integrally mold the resin and the sheet with each other.

Various sensing technologies using an image pickup element have been developed for devices providing an automatic vehicle driving technology or virtual and augmented realities (VR, AR). Such sensing technologies are capable of acquiring not only information perceptible by human sight, but also a lot of information by using polarized light that humans cannot see and wavelength components (for example, infrared rays).

In this situation, products having a design using an infrared absorbing ink as a design which can only be recognized by the sensing technology, or which can be recognized by both the sensing technology and sight have been proposed (for example, JP2015-515063A).

In addition, three-dimensional molded bodies having various functions imparted thereto are built in sensing devices, or VR image display devices or AR image display devices which can be visually recognized by humans. These three-dimensional molded bodies have various optical functions imparted thereto, which cannot be recognized by naked eyes, and contribute to increasing the functions of sensing devices and image display devices.

### SUMMARY OF THE INVENTION

The inventors have proposed using a design using polarized light as a method for realizing a molded body having such a design invisible to human sight, and performed studies on a liquid crystal film for three-dimensional molding including a liquid crystal layer in consideration of a degree of freedom in molding and a degree of freedom in optical characteristics which can be imparted.

Specifically, in order to impart functionality to a three-dimensional molded body which is applied to a sensing device, a VR image display device, or an AR image display device, the inventors produced a liquid crystal film for three-dimensional molding including a liquid crystal layer, and molded the film by a known molding method such as vacuum molding using a mold or the like. Then, they conducted studies on reproducibility of image light of the obtained three-dimensional molded body. The reproducibility of image light means whether an image derived from image light, applied to the obtained three-dimensional molded body, can be reproduced with good reproducibility.

As a result of the above evaluation, it was found that the reproducibility of image light may deteriorate according to the kind of the liquid crystal film for three-dimensional molding, and further improvement is required.

The present invention is contrived in view of the above circumstances, and an object thereof is to provide a liquid crystal film for three-dimensional molding from which a three-dimensional molded body which is excellent in reproducibility of image light can be obtained during image light irradiation.

Another object of the present invention is to provide a three-dimensional molded body and a method of manufacturing the three-dimensional molded body.

The inventors have made efforts to achieve the objects, and as a result, found that the objects can be achieved by the following configuration. That is, the present invention is as follows.

(1) A liquid crystal film for three-dimensional molding including: a substrate; and a functional layer,
in which the functional layer includes a liquid crystal layer, and the liquid crystal layer is made from a liquid crystal composition, and
a rubbing haze variation of an outermost surface of the functional layer is 0.8% or less.

(2) The liquid crystal film for three-dimensional molding according to (1), in which a coefficient of static friction of the outermost surface of the functional layer is less than 1.0.

(3) The liquid crystal film for three-dimensional molding according to (1) or (2), in which a breaking load of the functional layer is 0.10 mN/cm or greater.

(4) The liquid crystal film for three-dimensional molding according to any one of (1) to (3), in which the liquid crystal layer is placed on an outermost surface side of the functional layer.

(5) The liquid crystal film for three-dimensional molding according to any one of (1) to (4), in which the liquid crystal composition is a polymerizable liquid crystal composition.

(6) The liquid crystal film for three-dimensional molding according to (5), in which the polymerizable liquid crystal composition contains a polyfunctional polymerizable liquid crystal compound.

(7) The liquid crystal film for three-dimensional molding according to (5), in which the polymerizable liquid crystal composition contains a non-liquid crystalline polyfunctional polymerizable compound.

(8) The liquid crystal film for three-dimensional molding according to (7), in which the non-liquid crystalline polyfunctional polymerizable compound is an ester compound of a urethane polyol and a (meth)acrylic acid, or an ester compound of an ester polyol and a (meth)acrylic acid.

(9) The liquid crystal film for three-dimensional molding according to any one of (1) to (8), in which the liquid crystal composition contains a polymerizable liquid crystal compound, and
the polymerizable liquid crystal compound exhibits a smectic phase.

(10) A three-dimensional molded body including: the liquid crystal film for three-dimensional molding according to any one of (1) to (9); and a resin base, in which the liquid crystal film for three-dimensional molding and the resin base are molded integrally with each other.

(11) A method of manufacturing a three-dimensional molded body, including: a step 1 of premolding the liquid crystal film for three-dimensional molding according to any one of (1) to (9) through a vacuum molding step;

a step 2 of inserting the premolded liquid crystal film for three-dimensional molding in a predetermined position in an injection mold, and closing the mold; and

a step 3 of injecting a fluidized resin into a cavity formed by closing the injection mold to form a three-dimensional molded body in which the resin and the liquid crystal film for three-dimensional molding are integrated with each other.

(12) The method of manufacturing a three-dimensional molded body according to (11), further including: a step 4 of trimming an extra portion of the premolded liquid crystal film for three-dimensional molding between the steps 1 and 2.

(13) A method of manufacturing a three-dimensional molded body including: a step of vacuum-molding the liquid crystal film for three-dimensional molding according to any one of (1) to (9) to obtain a three-dimensional molded body.

(14) A three-dimensional molded body which is molded using the liquid crystal film for three-dimensional molding according to any one of (1) to (9).

According to the present invention, it is possible to provide a liquid crystal film for three-dimensional molding from which a three-dimensional molded body which is excellent in reproducibility of image light can be obtained during image light irradiation.

In addition, according to the present invention, it is possible to provide a three-dimensional molded body and a method of manufacturing the three-dimensional molded body.

### BRIEF DESCRIPTION OF THE DRAWINGS

FIG. 1 is a cross-sectional view schematically showing an example of a liquid crystal film for three-dimensional molding according to an embodiment of the present invention.

FIG. 2 is a schematic view showing a configuration of a lens element.

### DESCRIPTION OF THE PREFERRED EMBODIMENTS

Hereinafter, embodiments of the present invention will be described in detail. In this specification, a numerical range expressed using “to” means a range including numerical values before and after “to” as a lower limit and an upper limit.

Regarding angles, each of “orthogonal” and “parallel” means a range of strict angle ±10°, and regarding angles, “same” and “different” can be determined based on whether the angular difference is less than 5° or not.

In this specification, “visible light” is light ranging from 380 to 780 nm. In this specification, the measurement wavelength is 550 nm in a case where there are no particular additional notes in regard to the measurement wavelength.

Next, terms used in this specification will be described.

<Re (λ), Rth (λ)>

Values of in-plane retardation and retardation in thickness direction are values measured using AxoScan OPMF-1 (manufactured by OPTO SCIENCE, INC.) with the use of light at a measurement wavelength.

Specifically, by inputting an average refractive index ((nx+ny+nz)/3) and a film thickness (d (μm)) into AxoScan OPMF-1,

Slow Axis Direction)(°)

Re (λ)=R0 (λ)

Rth (λ)=((nx+ny)/2−nz)×d

are calculated.

R0 (λ) is displayed as a numerical value calculated by AxoScan OPMF-1, and means Re (λ).

[Liquid Crystal Film for Three-Dimensional Molding]

A liquid crystal film for three-dimensional molding according to an embodiment of the present invention includes at least a substrate and a functional layer.

The functional layer includes a liquid crystal layer, and the liquid crystal layer is made from a liquid crystal composition.

The rubbing haze variation of an outermost surface of the functional layer is 0.80% or less.

The rubbing haze variation mentioned here means a degree of haze variation of the whole liquid crystal film for three-dimensional molding before and after the outermost surface (the surface opposite to the substrate side) of the functional layer of the liquid crystal film for three-dimensional molding according to the embodiment of the present invention is rubbed by a rubbing test under specified conditions. That is, the rubbing haze variation is a value obtained by subtracting the haze before the rubbing test from the haze after the rubbing test.

The rubbing haze variation is preferably 0.75% or less, and more preferably 0.70% or less. The lower limit of the rubbing haze variation is not particularly limited, and for example, 0%.

As a method of measuring the rubbing haze variation, using a surface property measuring machine (“HEIDON TRIBOGEAR type 38” manufactured by Shinto Scientific Co., Ltd.), a haze variation of the liquid crystal film for three-dimensional molding before reciprocation of CANNEQUIN No. 3 as white cotton cloth for rubbing 50 times with a load of 500 gf on the outermost surface of the functional layer of the liquid crystal film for three-dimensional molding and after reciprocation ((haze of liquid crystal film for three-dimensional molding after reciprocation of CANNEQUIN No. 3)—(haze of liquid crystal film for three-dimensional molding before reciprocation of CANNEQUIN No. 3)) is measured. A haze meter NDH4000 manufactured by NIPPON DENSHOKU INDUSTRIES Co., Ltd. is used for haze measurement.

The method for achieving the above-described rubbing haze variation is not particularly limited, and examples thereof include a method using a liquid crystal composition containing a monomer for enhancing the toughness of the liquid crystal layer (for example, a urethane monomer. Specifically, an ester compound of a urethane polyol and a (meth)acrylic acid and the like), a method using a liquid crystal composition containing a polymerizable liquid crystal compound exhibiting a smectic phase, and a method of separately providing a surface protective layer on the liquid crystal layer.

The inventors have conducted studies on the cause of deterioration in reproducibility of image light of a three-dimensional molded body to be obtained, and found that the cause is that scratches or distortion are generated in the liquid crystal layer in a case where the liquid crystal film for three-dimensional molding is molded by a mold. That is, during mounting or removal of the liquid crystal film for three-dimensional molding in or from the forming mold and during injection molding, scratches or distortion were generated in the liquid crystal layer due to the stress and the like applied to the film, and thus image light entering the three-dimensional molded body to be obtained was scattered and caused image distortion.

On the other hand, by increasing the rub resistance of the outermost surface of the functional layer of the liquid crystal film for three-dimensional molding according to the embodiment of the present invention, the generation of scratches or distortion in the liquid crystal layer due to the stress and the like applied to the film during mounting or removal of the liquid crystal film for three-dimensional molding in or from the forming mold and during injection molding is suppressed, and thus a molded body exhibiting desired optical characteristics is obtained.

Hereinafter, the liquid crystal film for three-dimensional molding will be described in detail.

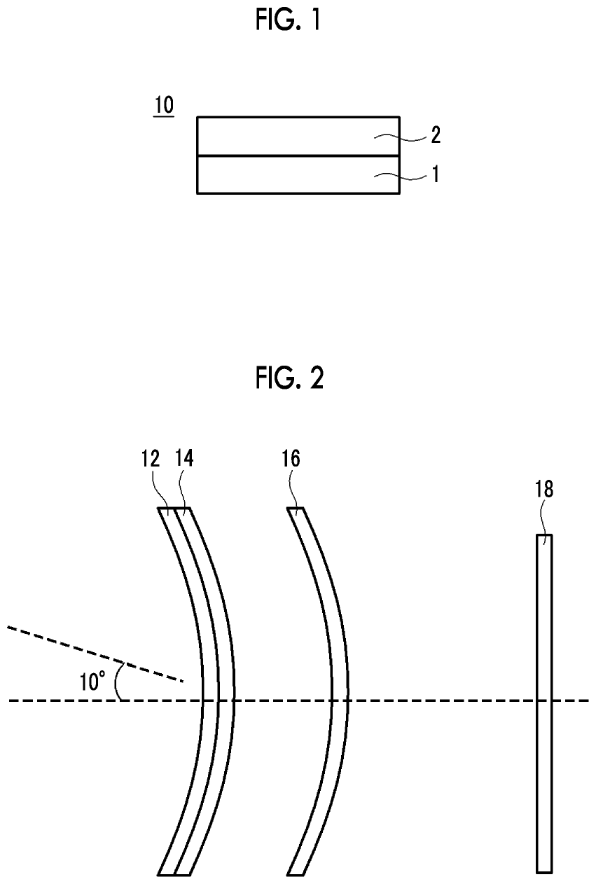

The liquid crystal film for three-dimensional molding according to the embodiment of the present invention includes at least a substrate 1 and a functional layer 2 including a liquid crystal layer (FIG. 1, the liquid crystal layer is not shown). Between the substrate and the liquid crystal layer, a surface reforming layer for reforming surface properties of the substrate, such as an easy adhesion layer, can be formed. In this case, the surface reforming layer is included in the substrate.

The functional layer can be formed by sequentially providing layers constituting the functional layer on the substrate. In addition, the functional layer may be provided on a temporary support, and then transferred to the substrate using an adhesive layer or the like. In this case, the adhesive layer is included in the functional layer.

The coefficient of static friction of the outermost surface of the functional layer of the liquid crystal film for three-dimensional molding according to the embodiment of the present invention is preferably less than 1.0. In a case where the coefficient of static friction of the outermost surface of the functional layer is within a predetermined range, the local stress generated by the friction between the mold and the functional layer generated during the molding of a sheet in the mold is reduced, and it is possible to obtain a molded body which is excellent in reproducibility of image light.

The lower limit of the coefficient of static friction of the outermost surface of the functional layer is not particularly limited, and is 0.2 or greater in many cases.

The coefficient of static friction is measured using a static friction measuring machine (friction measuring machine AN, manufactured by Toyo Seiki Seisaku-sho, Ltd.) under the condition of an inclination speed of 1 degree/sec.

In addition, the breaking load of the functional layer of the liquid crystal film for three-dimensional molding according to the embodiment of the present invention is preferably 0.10 mN/cm or greater. In a case where the functional layer can withstand a predetermined load, it is possible to prevent cracks from being generated due to deformation during molding.

The upper limit of the breaking load of the functional layer is not particularly limited, and is 4.0 mN/cm or less in many cases.

In the measurement of the breaking load of the functional layer, a polyethylene terephthalate film is bonded to a surface on the functional layer side of a sample having a support and a functional layer placed on the support via a UV adhesive, and a peeling test is performed by performing a 90-degree peeling test on the polyethylene terephthalate film using a Tensilon universal material tester. The obtained initial peeling load peak value is defined as the breaking strength of the film.

Examples of the support included in the sample having a functional layer used in the above evaluation include a resin sheet to be described later and a glass substrate. The sample may include an alignment layer for adjusting the alignment of the liquid crystal layer.

Hereinafter, the substrate and the functional layer including the liquid crystal layer, which constitute the liquid crystal film for three-dimensional molding, will be described in detail.

<Substrate>

The substrate is a member serving as a support for the functional layer. The substrate is selected in consideration of the suitability for vacuum molding and the suitability for simultaneous decoration in which the liquid crystal film is placed between the molds, and decoration is performed simultaneously with injection molding. Examples thereof include a resin sheet consisting of a thermoplastic resin.

General examples of the thermoplastic resin include an acrylic resin, a polyolefin-based resin such as polypropylene and polyethylene, a polycarbonate resin, an acrylonitrile-butadiene-styrene resin (hereinafter referred to as “ABS resin”), a vinyl chloride resin, a polyester-based resin, a cycloolefin resin and a cellulose ester resin. In addition, as the substrate, a single layer sheet of the above resin or a multilayer sheet composed of the same kind or different kinds of resins can be used. The substrate preferably includes an acrylic resin (particularly, a PMMA resin), a polycarbonate resin, or a cellulose ester resin from the viewpoint of excellent so-called trimming property with which an extra portion can be easily removed by hand or the like during the course of obtaining a molded body or a premolded body for providing a molded body from a sheet-like raw web.

The thickness of the substrate is selected according to the molding shape or application, and is usually about 0.02 to 1.0 mm, and generally about 0.03 to 0.5 mm.

The substrate may be transparent or opaque. In a case where the three-dimensional molded body is used as an optical member to be described later, a transparent substrate is preferably used. In addition, according to the application, the substrate may be an optical member having polarization selective absorptivity or polarization selective reflectivity (so-called polarizing plate), an optical member which reflects light or electromagnetic waves, a color filter which selectively absorbs light according to the wavelength, or the like.

As desired, a surface treatment such as a saponification method and an oxidation method can be performed on the surface of the above-described substrate in order to improve the adhesion to a layer to be provided on the substrate. In addition, an easy adhesion layer can be previously provided in the manufacturing of the substrate. In this case, the easy adhesion layer is included in the substrate.

Examples of the oxidation method include a corona discharge treatment, a chromium oxidation treatment, a flame treatment, a hot air treatment, and an ozone and ultraviolet treatment method. These surface treatments are appropriately selected according to the kind of the substrate, and a corona discharge treatment method is preferable from the viewpoint of effects, operability, and the like.

In addition, preferably, an antiblocking treatment is optionally performed on the surface of the substrate, opposite to the surface on which the functional layer including the liquid crystal layer is applied. Examples of the antiblocking treatment include a roughening treatment for the surface of the substrate, a treatment for applying a coating layer containing fine particles as an antiblocking agent, and a treatment for previously adding fine particles as an antiblocking agent to the substrate. In addition, a surface protective film which can be removed after molding may be provided, and an antiblocking function may be imparted to the surface protective film.

<Functional Layer>

The functional layer includes at least a liquid crystal layer, and the liquid crystal layer is made from a liquid crystal composition.

The functional layer may be composed only of a liquid crystal layer, or may be composed of a liquid crystal layer and other layers. The liquid crystal layer and other layers may be sequentially laminated. Otherwise, the liquid crystal layer and other layers may be formed integrally with each other and distinguished only by the uneven distribution of the components.

The position of the liquid crystal layer is not particularly limited. The liquid crystal layer may be positioned on the outermost surface side (the surface side opposite to the substrate) of the functional layer.

[Liquid Crystal Layer]

The liquid crystal layer included in the present invention is made from a liquid crystal composition. More specifically, the liquid crystal layer may be a layer obtained by causing a liquid crystal composition to be in a predetermined alignment state and by then fixing the alignment by a polymerization reaction or cooling. In a case where a polymerizable liquid crystal composition is used, the components contained in the liquid crystal layer after the polymerization reaction may no longer exhibit liquid crystal property. However, in this specification, the layers in such a case are also referred to as a liquid crystal layer.

The liquid crystal layer can be in an optional alignment state, and examples of the alignment include homogeneous alignment, homeotropic alignment, spray alignment, cholesteric alignment, twist alignment, and hybrid alignment. A plurality of alignment states may be laminated or arranged in the plane of the layer or in different states for each of the regions divided in a thickness direction. The optical characteristics of the liquid crystal layer can be selected according to the purpose, and functions, such as retardation properties such as in-plane retardation and thickness direction retardation, optical rotation, cholesteric reflectivity, diffraction, and depolarization properties, can be imparted. In addition, the liquid crystal layer may be transparent in a visible region or in an infrared region, and by adding a dichroic dye or inorganic anisotropic fine particles, light absorption characteristics having anisotropy-wavelength selectivity or polarized light emission characteristics may be imparted.

The liquid crystal layer may be a layer exhibiting uniform optical characteristics over the whole surface of the liquid crystal film for three-dimensional molding according to the embodiment of the present invention, or a layer in which a plurality of regions exhibiting different optical characteristics in the plane are patterned. The patterning may have a width or period of 5 cm to 1 mm and macroscopically constitute the design. Otherwise, the patterning may have a width or period of less than 1 mm and not macroscopically form the design, but may exhibit a unique optical effect.

{Liquid Crystal Composition}

The liquid crystal layer is formed of a liquid crystal composition containing a liquid crystal compound. The liquid crystal composition may be a liquid crystal composition containing a polymerizable liquid crystal compound which exhibits a liquid crystal property and has a polymerizable group in the molecule, or a liquid crystal composition containing a polymer liquid crystal compound. In addition, the liquid crystal composition may contain other polymerizable compounds, an alignment stabilizer, a polymerization initiator, a solvent, and the like. From the viewpoint of excellent strength, toughness, and heat resistance, the liquid crystal layer is particularly preferably a layer formed of a composition containing a compound having a polymerizable group (so-called polymerizable liquid crystal composition).

In the liquid crystal composition, the content of the liquid crystal compound is preferably 75 to 95 parts by mass, more preferably 75 to 90 parts by mass, and even more preferably 80 to 90 parts by mass with respect to 100 parts by mass of the total solid content in the liquid crystal composition. In a case where the content of the liquid crystal compound is within the above range, the optical anisotropy and the aligning property of the liquid crystals are improved, and desired optical characteristics are easily obtained.

The solid content means the components excluding the solvent in the liquid crystal composition. Even in a case where the components are liquids, these are calculated as solids.

(Polymer Liquid Crystal Compound)

Examples of the polymer liquid crystal compound include thermotropic liquid crystal polymers described in JP2011-237513A. In addition, the polymer liquid crystal compound may have a crosslinkable group (for example, an acryloyl group and a methacryloyl group) at a polymer terminal or in a side chain. The polymer liquid crystal compound may be a so-called main chain type liquid crystal polymer containing a mesogen in the polymer main chain, or may be a side chain type liquid crystal polymer containing a mesogen in the side chain. The polymer liquid crystal compound is preferably side chain type liquid crystal polymer from the viewpoint of excellent thermal properties such as a glass transition point and various phase transition points of the liquid crystals and an excellent degree of freedom in design of the optical anisotropy.

The polymer liquid crystal compound is preferably a polymer liquid crystal compound containing a repeating unit represented by General Formula (1)

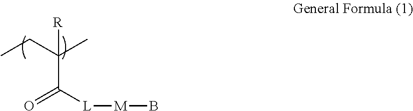

Here, in Formula (1),

R represents a hydrogen atom or a methyl group.

L represents a single bond or a divalent linking group.

B represents a hydrogen atom, a halogen atom, a cyano group, an alkyl group, an alkoxy group, an amino group, an oxycarbonyl group, an acyloxy group, an acylamino group, an alkoxycarbonylamino group, a sulfonylamino group, a sulfamoyl group, a carbamoyl group, an alkylthio group, a sulfonyl group, a sulfinyl group, a ureido group, or a crosslinkable group.

M represents a mesogenic group.

(Polymerizable Liquid Crystal Compound)

The polymerizable liquid crystal compound contained in the polymerizable liquid crystal composition has a refractive index anisotropy, and has a function of imparting desired optical characteristics by being in a predetermined alignment state.

Examples of the polymerizable liquid crystal compound include materials exhibiting a liquid crystal phase such as a nematic phase and a smectic phase. In addition, polymerizable liquid crystal molecules having various structures such as rod-like liquid crystal compounds and disk-like liquid crystal compounds can be used.

The wavelength dispersion of the refractive index anisotropy of the polymerizable liquid crystal compound may be any one of forward wavelength dispersion or reverse wavelength dispersion. Regarding the wavelength dispersion of the polymerizable liquid crystal compound mentioned, a case where in a film obtained by homogeneously aligning the polymerizable liquid crystal compound, the relationship between in-plane retardations Re (450), Re (550), and Re (650) of the film satisfies a relationship represented by Expression (1) or (2) is defined as the forward wavelength dispersion, and a case where the relationship satisfies a relationship represented by Expression (3) or (4) is defined as the reverse wavelength dispersion.

Re(450)/Re(550)≥1 (1)

Re(650)/Re(550)≤1 (2)

Re(450)/Re(550)≤1 (3)

Re(650)/Re(550)≥1 (4)

As the polymerizable liquid crystal compound used in this embodiment, compounds described in JP1996-050206A (JP-H8-050206A), JP2007-002220A, JP2010-244038A, JP2008-19240A, JP2013-166879A, JP2014-078036A, JP2014-198813A, JP2011-006360A, JP2011-006361A, JP2011-207765A, JP2008-273925A, and JP2015-200877A can be used. In addition, a plurality of different polymerizable liquid crystal compounds can be mixed and used.

The polymerizable liquid crystal compound preferably has two or more polymerizable groups (for example, acryloyl group) in the molecule. That is, the polymerizable liquid crystal compound is preferably a polyfunctional polymerizable liquid crystal compound having two or more polymerizable groups. In a case where two or more polymerizable groups are included in the molecule, the crosslinking structure of a polymer made from the polymerizable liquid crystal compound becomes tough, and thus it is possible to obtain a liquid crystal film for three-dimensional molding in which defects such as scratches or distortion are hardly generated without destruction or large deformation of a liquid crystal layer even in a case where rubbing or deformation stress is applied.

In addition, the polymerizable liquid crystal compound is preferably a polymerizable liquid crystal compound exhibiting a smectic phase. By fixing the liquid crystal layer with a smectic phase using the polymerizable liquid crystal compound exhibiting the smectic phase, the optical characteristics of the liquid crystal layer hardly changes even in a case where heating and stress are applied during molding, and moreover, the layer structure is dense and strong. Whereby, it is possible to obtain a liquid crystal film for three-dimensional molding in which defects such as scratches or distortion are hardly generated.

(Other Polymerizable Compounds)

The polymerizable compound contained in the polymerizable liquid crystal composition is preferably a non-liquid crystalline polyfunctional polymerizable compound.

Examples of the non-liquid crystalline polyfunctional polymerizable compound include known polyhydric alcohols and ester compounds of (meth)acrylic acids. Examples of the polyhydric alcohol include glycerin, trimethylolpropane, pentaerythritol, dipentaerythritol, ester polyols obtained from polyhydric alcohols and polycarboxylic acids, and urethane polyols obtained from polyhydric alcohols and polyhydric isocyanates. From the viewpoint of imparting toughness and easy moldability to the liquid crystal layer, ester compounds of ester polyols and (meth)acrylic acids or ester compounds of urethane polyols and (meth)acrylic acids are preferable.

Examples of the ester compounds of urethane polyols and (meth)acrylic acids include EBECRYL 1290 (manufactured by DAICEL-ALLNEX LTD.), Laromer LR9000 (manufactured by BASF SE), and EB1290 (manufactured by DAICEL-ALLNEX LTD.) which are used in Examples to be described later.

The number of polymerizable groups included in the molecule of the non-liquid crystalline polyfunctional polymerizable compound is preferably 2 to 8, and more preferably 3 to 6.

(Alignment Stabilizer)

The liquid crystal composition may contain an alignment stabilizer.

By adding the alignment stabilizer, various disturbing factors are suppressed, and the alignment of the liquid crystal compound is stabilized, so that a liquid crystal layer with less retardation unevenness can be obtained. In addition, by appropriately selecting the structure of the alignment stabilizer, the alignment of the liquid crystal layer can be adjusted to optional alignment such as horizontal alignment, vertical alignment, hybrid alignment, or cholesteric alignment.

The alignment stabilizer is preferably an acrylic polymer having a fluoroaliphatic moiety in a side chain (described in paragraphs 0022 to 0063 in JP2008-257205A and paragraphs 0017 to 0124 in JP2006-91732A) from the viewpoint of achieving both alignment stabilization and leveling. By using an acrylic polymer having a fluoroaliphatic moiety in a side chain, the coefficient of static friction of the surface of the functional layer including the liquid crystal layer can be reduced.

(Polymerization Initiator)

The liquid crystal composition may contain a polymerization initiator.

Various polymerization initiators can be selected according to the polymerizable group of the polymerizable liquid crystal compound. Preferable examples of the combination of the polymerizable liquid crystal compound with the polymerization initiator include a combination in which the polymerizable liquid crystal compound is a (meth)acrylate compound and the polymerization initiator is a radical polymerization initiator.

Examples of the polymerization initiator include various known polymerization initiators. In order to realize desired alignment, a compound which is excellent in excellent temporal stability of the composition and in deep curability of the coating film is preferable. From such a viewpoint, an oxime ester compound (U.S. Pat. No. 4,255,513A, JP2001-233842A, and the like) or an acylphosphine oxide compound (JP1993-029234B (JP-H5-029234B), JP1998-095788A (JP-H10-095788A), JP1998-029997A (JP-H10-029997A), and the like) is preferable.

(Solvent)

The liquid crystal composition may contain a solvent.

Examples of the solvent include various known solvents. In a case where the solvent is selected, it is preferably selected in consideration of the solubility of the polymerizable liquid crystal compound and other components, the wettability of the liquid crystal composition to the substrate, the surface tension, the viscosity, and the volatility.

The content of the solvent in the liquid crystal composition is preferably 50 to 90 mass %, and more preferably 60 to 85 mass % with respect to the total amount of the liquid crystal composition.

(Other Components)

Examples of other components which may be contained in the liquid crystal composition include a dye, a UV absorber, and a non-polymerizable functional additive. In particular, in a case where a rod-like dichroic dye is used as the dye, it is possible to impart dichroic absorption characteristics according to the alignment of the liquid crystals. By imparting dichroic absorption characteristics to the liquid crystal layer, the liquid crystal layer can be used as an absorption type polarizer.

Preferable examples of the dichroic dye include azo dyes described in examples in JP2013-101328A.

{Other Layers}

Examples of other layers which may be included in the functional layer include an alignment layer, a surface protective layer, and a colored layer.

The alignment layer is formed on the substrate, and the liquid crystal compound of the liquid crystal layer formed on the alignment layer can be aligned by the alignment restriction force of the alignment layer.

As the alignment layer, various configurations capable of aligning the liquid crystal compound to be formed as the liquid crystal layer can be applied. Examples thereof include a rubbed film of a layer containing an organic compound such as a polymer, an obliquely vapor-deposited film of an inorganic compound, a film having microgrooves, and a film obtained by accumulating Langmuir-Blodgett (LB) films of an organic compound such as a co-tricosanoic acid, dioctadecylmethylammonium chloride, or methyl stearylate by Langmuir-Blodgett method. An alignment film in which an alignment function is generated by light irradiation is also included.

The alignment layer is preferably a layer formed by rubbing a surface of a layer (polymer layer) containing an organic compound such as a polymer. The rubbing treatment is performed by rubbing a surface of a polymer layer with paper or cloth several times in a certain direction. Preferable examples of the polymer used for forming the alignment layer include polyimide, polyvinyl alcohol, modified polyvinyl alcohol described in paragraphs 0071 to 0095 in JP3907735B, and polymers having a polymerizable group described in JP1997-152509A (JP-H9-152509A).

In addition, as the alignment layer, a so-called photo-alignment layer (photo-alignment film) which is obtained by irradiating a photo-aligning material with polarized light or unpolarized light to form an alignment layer is also preferable. Preferably, a photo-alignment layer having an alignment restriction force is formed through a step of performing polarized light irradiation in a vertical direction or an oblique direction or a step of performing unpolarized light irradiation in an oblique direction. Using the photo-alignment layer, it is possible to align the liquid crystal compound with excellent symmetry.

A photo-alignment film capable of imparting an alignment restriction force in a contactless manner is preferable from the viewpoint that foreign matter defects are suppressed and a liquid crystal film for three-dimensional molding without unevenness is obtained.

To form the photo-alignment layer, a coating liquid to be formed as a photo-alignment layer is applied and dried to form a material layer to be a photo-alignment layer on a long substrate, and then ultraviolet irradiation by linearly polarized light is performed thereon. As the material to be formed as the photo-alignment layer, various materials to which a photo-alignment method can be applied can be applied. For example, photo-dimerization type materials, particularly, compounds containing a cinnamic acid derivative can be used. In addition, photo-isomerization materials such as an azo compound can also be preferably used.

The thickness of the alignment layer is not particularly limited as long as the alignment function can be exhibited. The thickness is preferably 0.01 to 5 μm, more preferably 0.05 to 2 μm, and even more preferably 0.1 to 0.5 μm. In a case where the thickness of the alignment layer is within the above range, an excellent alignment restriction force can be exhibited, and foreign matter defects are greatly suppressed.

The substrate and the alignment layer may be separately provided as layers fulfilling their respective functions. An aspect in which the substrate also serves as the alignment layer, that is, the surface of the substrate has an alignment restriction force may also be adopted. In addition, in a case where the substrate and the alignment layer are separately provided, the substrate and the alignment layer may be provided in contact with each other, or other layers may be interposed between the substrate and the alignment layer.

Examples of the method of directly imparting an alignment restriction force without providing an alignment layer on the surface of the substrate include a method of performing a treatment such as the rubbing or polarized light irradiation described above on the surface of the substrate, and a method of aligning the polymer constituting the substrate in a certain direction by stretching the substrate.

In a case where the alignment layer is provided on the substrate, examples of other layers described above which can be interposed between the substrate and the alignment layer include a barrier layer and an impact relaxing layer, and these are included in the functional layer. In a case where the functional layer or the liquid crystal layer is formed on a temporary support different from the substrate, and then transferred to the substrate to obtain a liquid crystal film for three-dimensional molding according to the embodiment of the present invention, the present invention is not necessarily limited to the above-described aspect.

A surface protective layer can be provided on the outermost surface side of the functional layer to protect the liquid crystal layer. The liquid crystal layer and the surface protective layer may be in direct contact with each other, or laminated with other layers (barrier layer, impact relaxing layer, easy adhesion layer, and the like) interposed therebetween. The surface protective layer is preferably a layer made from a curable resin composition, and is preferably cured by crosslinking.

The thickness of the surface protective layer is appropriately set according to the application, and is preferably 0.5 to 10 μm, and more preferably 0.7 to 5 μm from the viewpoint of achieving both shape followability to the forming mold and surface protection function. An antiglare property and an antiblocking property may be imparted to a surface of the surface protective layer as long as the optical characteristics of the liquid crystal layer are not affected.

Examples of the curable resin composition include a composition containing a monomer, an oligomer and/or a prepolymer containing a polymerizable group such as a (meth)acryloyl group, an epoxy group, and an oxetanyl group, and a thermally crosslinkable resin composition such as a polyamic acid, a polyimide precursor, and melamine. As a curable resin composition containing a (meth)acryloyl group as a polymerizable group, a mixture of: polycarbonate (meth)acrylate or acrylic silicone (meth)acrylate; and polyfunctional (meth)acrylate is preferable from the viewpoint that the mixture has excellent rub resistance and moldability and effectively protects the liquid crystal layer. A polymerization initiator, a crosslinking catalyst, a surfactant, an antistatic agent, an antiblocking agent, and the like may be optionally added to the curable resin composition. A fluorine-based or silicone-based surfactant is preferably used since the coefficient of static friction of the surface of the functional layer is reduced.

In addition, the curable resin composition may contain the ester compound of a urethane polyol and a (meth)acrylic acid described above.

A colored layer can be provided at an optional position to additionally impart a design which can be recognized by human sight. As a composition constituting the colored layer, various known compositions which can be used for the liquid crystal film for three-dimensional molding can be used without limitation. The colored layer refers not only to a layer having absorption in the visible region but also to the entire layer capable of imparting a human-visible design by reflection or scattering.

The thickness of the colored layer and the degree of coloring are appropriately selected according to the application. In addition, the above-described surface protective layer or alignment layer may also serve as a colored layer.

[Method of Manufacturing Liquid Crystal Film for Three-Dimensional Molding]

The method of manufacturing a liquid crystal film for three-dimensional molding according to the embodiment of the present invention is not particularly limited, and for example, the film can be manufactured by the following method.

i) a step of optionally providing an alignment layer on a substrate or performing an alignment treatment on the substrate,

ii) a step of applying a polymerizable liquid crystal composition to the alignment layer or the substrate subjected to the alignment treatment,

iii) a step of causing a coating film of the polymerizable liquid crystal composition to be in a predetermined alignment state, and then fixing the alignment by polymerization, and

iv) a step of optionally providing a surface protective layer.

In a case where the liquid crystal film for three-dimensional molding is manufactured by the steps (i) to (iii), the functional layer is the liquid crystal layer itself, and in a case where the liquid crystal film for three-dimensional molding is manufactured by the steps (i) to (iv), the functional layer is composed of the liquid crystal layer and the surface protective layer.

Examples of other aspects of the method of manufacturing a liquid crystal film for three-dimensional molding according to the embodiment of the present invention include a manufacturing method including the following steps.

i) a step of optionally providing an alignment layer on a temporary support or performing an alignment treatment on the temporary support,

ii) a step of applying a polymerizable liquid crystal composition to the alignment layer or the temporary support subjected to the alignment treatment,

iii) a step of causing a coating film of the polymerizable liquid crystal composition to be in a predetermined alignment state, and then fixing the alignment by polymerization, and

iv) a step of laminating a liquid crystal layer on the substrate with an adhesive layer interposed therebetween, and then removing the temporary support.

In a case where the alignment film is provided in the above-described step i) and the temporary support is removed by peeling between the temporary support and the alignment film in the step iv), the functional layer is composed of the adhesive layer, the liquid crystal layer, and the alignment layer. In addition, in a case where no alignment film is provided in the step i) or the alignment layer is removed together with the temporary support in the step iv), the functional layer is composed of the adhesive layer and the liquid crystal layer. In addition, a surface protective layer may be optionally provided after the step iv), and in this case, the functional layer also includes the surface protective layer.

As a method of applying the liquid crystal layer, the alignment layer, the surface protective layer, and the adhesive layer, known methods can be used. Examples thereof include known coating methods such as a die coating method, a dip coating method, an air knife coating method, a curtain coating method, a roller coating method, a wire bar coating method, a gravure coating method, and a slide coating method.

As for the liquid crystal layer as a functional layer, only one liquid crystal layer or a plurality of liquid crystal layers may be included in the liquid crystal film for three-dimensional molding. In a case where the liquid crystal layer is placed on the outermost surface side of the functional layer, the rubbing haze variation may be 0.80% or less in the liquid crystal layer placed on the outermost surface, the coefficient of static friction of the liquid crystal layer on the outermost surface is preferably less than 1.0, and the breaking load of the liquid crystal layer on the outermost surface is preferably 0.10 mN/cm or greater.

[Three-Dimensional Molded Body]

The three-dimensional molded body according to the embodiment of the present invention is a three-dimensional molded body formed (molded) of the above-described liquid crystal film for three-dimensional molding.

As an example of the three-dimensional molded body, typically, the liquid crystal film for three-dimensional molding according to the embodiment of the present invention and a resin base are laminated in this order from the visual side of the three-dimensional molded body. A three-dimensional molded body in which the liquid crystal film for three-dimensional molding and the resin base are molded integrally with each other is particularly preferable.

Specific examples of the three-dimensional molded body include bumpers, body panels, headlight covers, bonnet covers, and license plates for vehicles; interior panels, wallboards, and curve mirrors for vehicles or for building use; housings, exterior components, switches, keys, keypads, handles, levers, and buttons for electronics, various equipment products, home appliances and AV devices such as personal computers, and mobile phones and devices; cosmetics cases, and cases for general merchandise.

Moreover, the three-dimensional molded body can also be applied to plastic lenses, curved window members, front protective plates for curved displays, apertures, and optical components such as polygon mirrors, and can exhibit excellent optical characteristics.

As the resin base, a resin according to the application is used, and examples thereof include polyolefin-based resins such as polyethylene and polypropylene, and thermoplastic resins such as an ABS resin, a styrene resin, a polycarbonate resin, an acrylic resins, and a vinyl chloride resin. Thermosetting resins such as a urethane resin and an epoxy resin may also be used.

[Method of Manufacturing Three-Dimensional Molded Body]

A three-dimensional molded body can be manufactured by using the liquid crystal film for three-dimensional molding according to the embodiment of the present invention in various injection molding methods such as an insert molding method, a method for simultaneous decoration with injection molding, a blow molding method, and a gas injection molding method. A three-dimensional molded body obtained by molding the liquid crystal film for three-dimensional molding according to the embodiment of the present invention may be provided by using and molding only the liquid crystal film for three-dimensional molding, or by molding the liquid crystal film for three-dimensional molding integrally with a resin base.

In an insert molding method as a preferable aspect, through
a step of premolding the liquid crystal film for three-dimensional molding according to the embodiment of the present invention through a vacuum molding step,
a step of optionally trimming an extra portion of the premolded liquid crystal film for three-dimensional molding,
a step of inserting the premolded liquid crystal film for three-dimensional molding in a predetermined position in an injection mold, and closing the mold, and
a step of injecting a fluidized resin into a cavity formed by closing the injection mold to form a three-dimensional molded body in which the resin and the liquid crystal film for three-dimensional molding are integrated with each other,

a three-dimensional molded body according to the embodiment of the present invention can be obtained.

In a three-dimension overlay method (TOM) as a preferable aspect, through
a step of bringing the liquid crystal film for three-dimensional molding according to the embodiment of the present invention into contact with a resin base via an adhesive,
a step of deforming the liquid crystal film for three-dimensional molding into a shape of the resin base by vacuum molding, and
a step of optionally trimming an extra portion of the liquid crystal film for three-dimensional molding, and obtaining a three-dimensional molded body in which the liquid crystal film for three-dimensional molding and the resin base are integrated with each other,

a three-dimensional molded body according to the embodiment of the present invention can be obtained.

As another preferable aspect, a step of vacuum-molding the liquid crystal film for three-dimensional molding according to the embodiment of the present invention to obtain a three-dimensional molded body may be performed to obtain a three-dimensional molded body.

### EXAMPLES

Hereinafter, the present invention will be described in detail with examples.

### Example 1

A coating liquid 1 for forming a photo-alignment film was prepared with reference to the description in Example 3 in JP2012-155308A, and applied to a commercially available triacetyl cellulose film (trade name: Z-TAC, manufactured by FUJIFILM Corporation) using a wire bar. The obtained film was dried with hot air at 60° C. for 60 seconds to produce an alignment film P-1 having a thickness of 300 nm.

The following polymerizable liquid crystal composition 1 was continuously applied to the above-described alignment film P-1. The formed coating film was heated at 60° C. under a heated atmosphere and irradiated with ultraviolet rays (300 mJ/cm²) at 70° C. under a nitrogen purge (oxygen concentration: 100 ppm) to fix the alignment of the liquid crystal compound. Thus, a retardation film was formed, and a liquid crystal layer 1 was produced. The in-plane retardation Re (550) of the liquid crystal layer 1 was 137 nm, and wavelength dispersion was forward wavelength dispersion.

(Polymerizable Liquid Crystal Composition 1)

| | |
|---|---|
| The following rod-like liquid crystal compound (M-1) | 83 parts by mass |
| The following rod-like liquid crystal compound (M-2) | 15 parts by mass |
| The following rod-like liquid crystal compound (M-3) The following urethane monomer (EBECRYL 1290, | 2 parts by mass 3.3 parts by mass |
| manufactured by DAICEL-ALLNEX LTD.) | |
| The following polymerization initiator | 4 parts by mass |
| (Irgacure OXE01, manufactured by BASF SE) | |
| The following fluorine-based polymer (M-4) | 0.3 parts by mass |
| The following fluorine-based polymer (M-5) | 0.1 parts by mass |
| Toluene | 552 parts by mass |
| Methyl ethyl ketone (MEK) | 138 parts by mass |

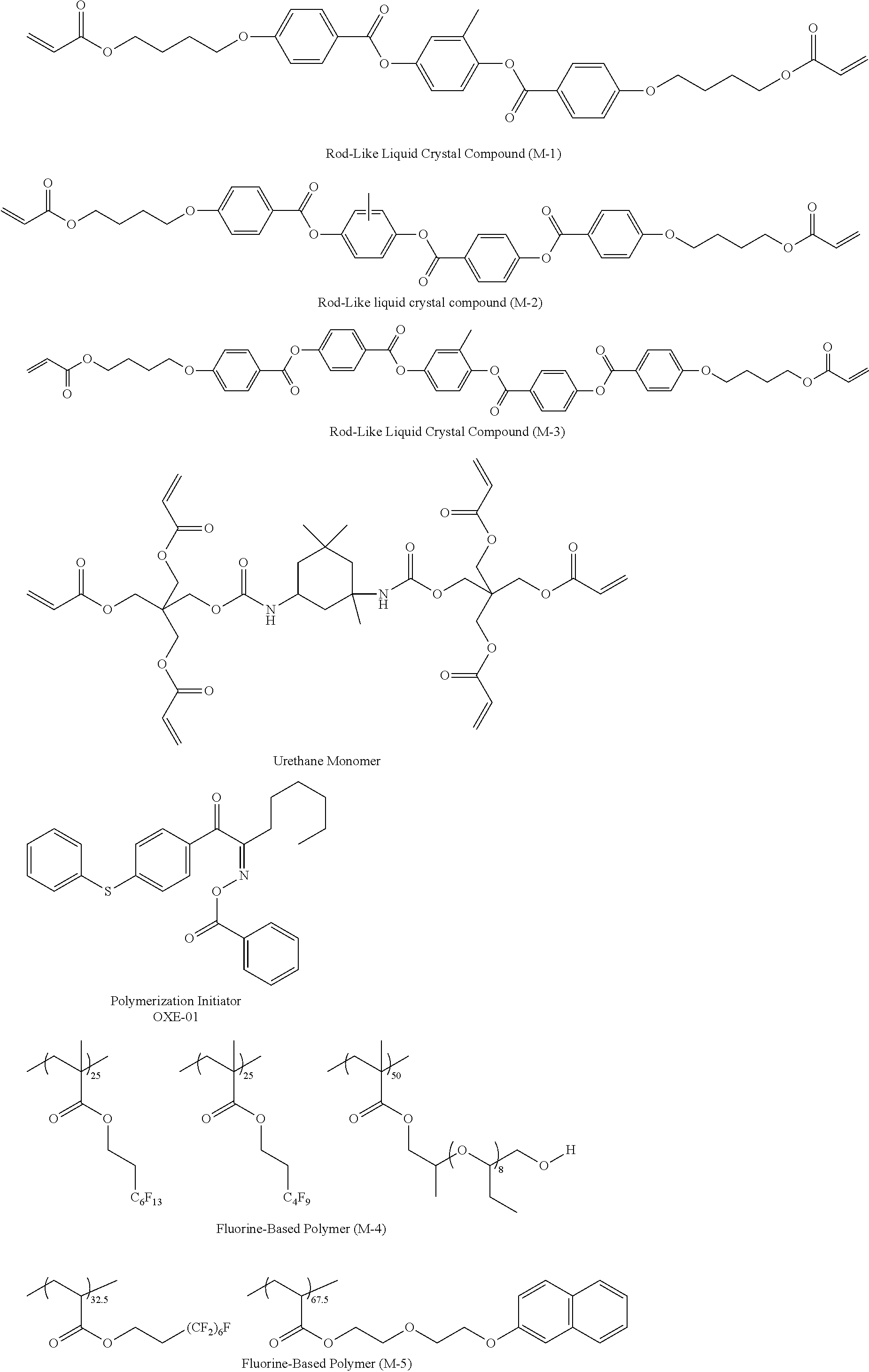

A laminate obtained as above was used as a liquid crystal film 1 for three-dimensional molding.

### Example 2

The polymerizable liquid crystal composition 1 in Example 1 was replaced with the following polymerizable liquid crystal composition 2, the heating temperature of the coating film was changed from 60° C. to 90° C., and the exposure amount was 1,000 mJ/cm². As a result, a liquid crystal film 2 for three-dimensional molding including a liquid crystal layer 2 as a functional layer was obtained.

The in-plane retardation Re (550) of the liquid crystal layer 2 was 137 nm, and wavelength dispersion was reverse wavelength dispersion. In addition, the obtained liquid crystal layer exhibited characteristics of a smectic phase.

(Polymerizable Liquid Crystal Composition 2)

| | |
|---|---|
| The following rod-like liquid crystal compound (S-1) | 57.5 parts by mass |
| The following rod-like liquid crystal compound (S-2) | 30 parts by mass |
| The following rod-like liquid crystal compound (L-1) | 12.5 parts by mass |
| Photopolymerization initiator | 6.0 parts by mass |
| (Irgacure 819, manufactured by BASF SE) | |
| The above-described fluorine-containing | 0.85 parts by mass |
| compound M-5 | |
| Cyclopentanone | 600 parts by mass |

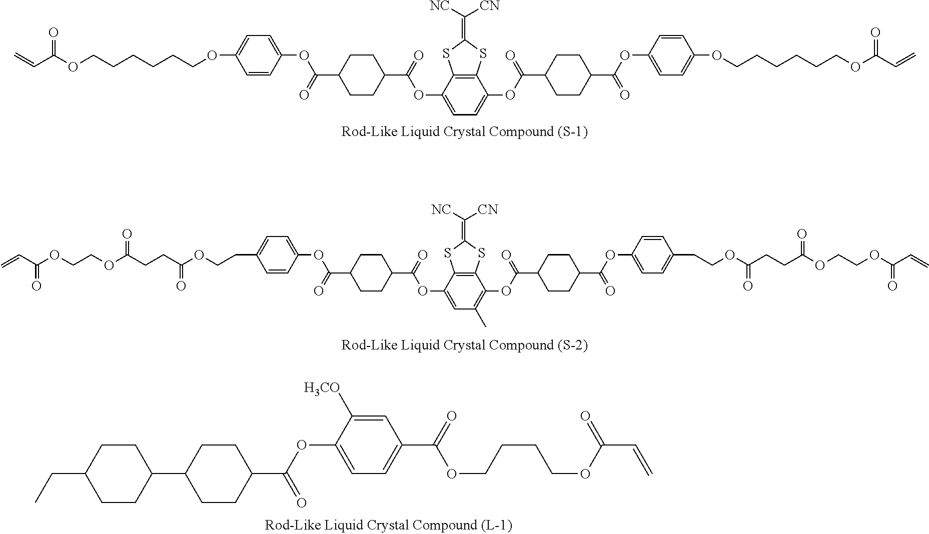

### Example 3

A liquid crystal layer 3 was formed in the same manner as in Example 1, except that the polymerizable liquid crystal composition 1 in Example 1 was replaced with the following polymerizable liquid crystal composition 3, and the heating temperature of the coating film was changed from 60° C. to 110° C., and a liquid crystal film 3 for three-dimensional molding including the liquid crystal layer 3 as a functional layer was obtained. The in-plane retardation Re (550) of the liquid crystal layer 3 was 138 nm, and wavelength dispersion was reverse wavelength dispersion.

(Polymerizable Liquid Crystal Composition 3)

| | |
|---|---|
| The following rod-like liquid crystal compound (Z-1) | 97 parts by mass |
| Urethane acrylate | 3 parts by mass |
| (“Laromer LR9000” manufactured by BASF SE) | |
| The following polymerization initiator | 3 parts by mass |
| (Irgacure OXE01, manufactured by BASF SE) | |
| Surfactant | 0.3 parts by mass |
| (“MEGAFACE 562” manufactured | |
| by DIC Corporation) | |
| Cyclopentanone | 146 parts by mass |
| 1,3-Dioxolane | 220 parts by mass |

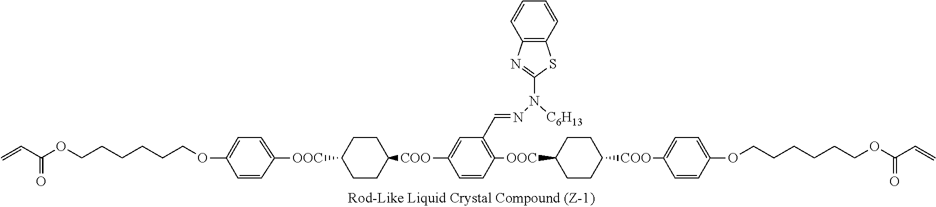

### Example 4

A liquid crystal layer 4 was formed in the same manner as in Example 1, except that the polymerizable liquid crystal composition 1 in Example 1 was replaced with the following polymerizable liquid crystal composition 4. The in-plane retardation Re (550) of the liquid crystal layer 4 was 137 nm, and wavelength dispersion was forward wavelength dispersion.

(Polymerizable Liquid Crystal Composition 4)

| | |
|---|---|
| The above-described rod-like liquid crystal | 83 parts by mass |
| compound (M-1) | |
| The above-described rod-like liquid crystal | 15 parts by mass |
| compound (M-2) | |
| The above-described rod-like liquid crystal | 2 parts by mass |
| compound (M-3) | |
| Polymerization initiator (Irgacure OXE01, | 4 parts by mass |
| manufactured by BASF SE) | |
| The above-described fluorine-based polymer (M-4) | 0.3 parts by mass |
| The above-described fluorine-based polymer (M-5) | 0.1 parts by mass |
| Toluene | 552 parts by mass |
| Methyl ethyl ketone (MEK) | 138 parts by mass |

A composition for forming a surface protective layer having the following composition was applied to the liquid crystal layer 4, and UV exposure (300 mJ/cm²) was performed thereon under a nitrogen atmosphere to provide a surface protective layer. Whereby, a liquid crystal film 4 for three-dimensional molding including a functional layer including the liquid crystal layer 4 and the surface protective layer was obtained. The surface protective layer was provided so as to have a thickness of 1 μTn.

(Composition for Forming Surface Protective Layer)

| | |
|---|---|
| The above-described urethane | 97 parts by mass |
| monomer (EBECRYL 1290, | |
| manufactured by DAICEL-ALLNEX LTD.) | |
| The above-described fluorine-based polymer M-5 | 1 part by mass |
| Polymerization initiator (Irgacure 189, | 2 parts by mass |
| manufactured by BASF SE) | |

### Comparative Example 1

A liquid crystal film C1 for three-dimensional molding as a comparative example was produced in the same manner as in Example 4, except that no surface protective layer was provided in Example 4.

### Comparative Example 2

A liquid crystal film C2 for three-dimensional molding as a comparative example was produced in the same manner as in Example 3, except that the amount of the urethane monomer (Laromer LR9000) added in the polymerizable liquid crystal composition 3 was zero in Example 3.

[Evaluation of Liquid Crystal Film for Three-dimensional Molding]

The obtained liquid crystal films for three-dimensional molding of the examples and the comparative examples were evaluated as follows. The results are shown in Table 1.

(Rubbing Haze Variation) Using a surface property measuring machine (“HEIDON TRIBOGEAR type 38” manufactured by Shinto Scientific Co., Ltd.), a haze variation of the liquid crystal film for three-dimensional molding before reciprocation of CANNEQUIN No. 3 as white cotton cloth for rubbing 50 times with a load of 500 gf on the surface of the functional layer of the obtained liquid crystal film for three-dimensional molding and after reciprocation was measured. A haze meter NDH4000 manufactured by NIPPON DENSHOKU INDUSTRIES Co., Ltd. was used for haze measurement.

(Coefficient of Static Friction) The coefficient of static friction of the surface of the functional layer of the obtained liquid crystal film for three-dimensional molding was measured at an inclination speed of 1 degree/sec using a static friction measuring machine (friction measuring machine AN, manufactured by Toyo Seiki Seisaku-sho, Ltd.)

(Breaking Strength of Film) Test samples were produced in which in the examples and the comparative examples, instead of the above-described photo-alignment film, an alignment film obtained by rubbing a polyimide film provided on a surface of a glass plate was used to provide a liquid crystal layer. The test sample had a three-layer configuration including a glass plate, an alignment film, and a liquid crystal layer.

A polyethylene terephthalate film was bonded to a surface (surface on the liquid crystal layer side) of the test sample via a UV adhesive, and a peeling test was performed by performing a 90-degree peeling test on the film (polyethylene terephthalate film) using a Tensilon universal material tester. The obtained initial peeling load peak value was defined as the breaking strength of the film.

(Appearance Evaluation, Extinction Evaluation, and Trimming Evaluation)

The liquid crystal film for three-dimensional molding of each of the examples and the comparative examples was applied to a spherical crown-like forming mold having a diameter of 70 mm and a depth of 10 mm, heated to 150° C. by an infrared heater, and then premolded by vacuum molding.

The obtained premolded body was visually evaluated. Those with visible scratches (including cracks, fogging, and the like in addition to abrasions) were evaluated as “B” in appearance, and those with good appearance were evaluated as “A” in appearance.

In addition, the premolded body was put between two polarizers placed in crossed Nicols, irradiated with 550 nm light, and observed in various directions to observe light leak (it acts as a λ/4 plate under ordinary circumstances. However, in a case where there is distortion due to deformation, the extinction position shifts from the original position, and light leak occurs). Those in which a predetermined extinction position was maintained as a whole were evaluated as “A” in extinction, those in which light leak was observed in less than 10% of the total area of the spherical crown were evaluated as “B” in extinction, and those in which light leak was observed in 10% or greater of the total area of the spherical crown were evaluated as “C” in extinction.

In addition, an unnecessary portion around the spherical crown was trimmed by hand to confirm whether the trimming is possible. Those in which it was possible to trim the unnecessary portion without burrs or cracks were evaluated as “A” in trimming, and those in which it was not possible to remove the unnecessary portion by hand and those in which burrs or cracks were generated on the spherical crown side were evaluated as “B” in trimming. The results are shown in Table 1.

(Evaluation of Three-Dimensional Molded Body)

The premolded body obtained in the above section (Appearance Evaluation, Extinction Evaluation, and Trimming Evaluation) was set in an injection mold, and a PMMA resin was injected into and molded in a cavity formed by closing the injection mold. Whereby, a spherical crown-like plastic optical member having a resin base thickness of 1 mm, a diameter of 70 mm, and a depth of 10 mm was obtained. The appearance and the extinction were confirmed in the same manner as in the above section (Appearance Evaluation, Extinction Evaluation, and Trimming Evaluation). The results are shown in Table 1.

TABLE 1

| | | | Rubbing | Coeffi- | Breaking | Premolded | | | Three-Dimensional | |
|---|---|---|---|---|---|---|---|---|---|---|
| | | | Haze | cient of | Load | Product | | | Molded Body | |
| | Liquid Crystal Film for | Wavelength | Variation | Static | (mN/ | Appear- | Extinc- | Trimming | Appear- | Extinc- |
| | Three-Dimensional Molding | Dispersion | (%) | Friction | cm) | ance | tion | Property | ance | tion |
| Example 1 | Liquid Crystal Film 1 for | forward | 0.68 | 0.3 | 0.22 | A | A | A | A | A |
| | Three-Dimensional Molding | dispersion | | | | | | | | |
| Example 2 | Liquid Crystal Film 2 for | reverse | 0.38 | 0.3 | 0.12 | A | A | A | A | A |
| | Three-Dimensional Molding | dispersion | | | | | | | | |
| Example 3 | Liquid Crystal Film 3 for | reverse | 0.72 | 1.1 | 0.10 | A | A | A | A | B |
| | Three-Dimensional Molding | dispersion | | | | | | | | |
| Example 4 | Liquid Crystal Film 4 for | forward | 0.21 | 0.8 | 0.28 | A | A | A | A | A |
| | Three-Dimensional Molding | dispersion | | | | | | | | |
| Comparative | Liquid Crystal Film C1 for | forward | 0.84 | 0.3 | 0.09 | B | A | A | B | A |
| Example 1 | Three-Dimensional Molding | dispersion | | | | | | | | |
| Comparative | Liquid Crystal Film C2 for | reverse | 0.82 | 1.2 | 0.08 | B | B | A | B | C |
| Example 2 | Three-Dimensional Molding | dispersion | | | | | | | | |

### Example 5

The following polymerizable liquid crystal composition 5 was applied to a cellulosic polymer film (TG40, manufactured by FUJIFILM Corporation) using a #3.5 wire bar. Then, it was heated with hot air at 40° C. for 60 seconds to dry the solvent in the composition and to align and mature the liquid crystal compound, and then irradiated with ultraviolet rays (300 mJ/cm²) at 40° C. under a nitrogen purge (oxygen concentration: 100 ppm) to fix the alignment of the liquid crystal compound. Thus, a retardation film was formed, and a liquid crystal layer 5 was produced. In the liquid crystal layer 5, the mesogen was vertically aligned, and the three-dimensional refractive index measured by AxoScan OPMF-1 (manufactured by Opto Science, Inc.) exhibited a relationship of nx=ny<nz. The in-plane retardation is represented by Re (550)=1 nm.

Polymerizable Liquid Crystal Composition 5

| | |
|---|---|
| The above-described rod-like liquid | 83 parts by mass |
| crystal compound (M-1) | |
| The above-described rod-like liquid | 15 parts by mass |
| crystal compound (M-2) | |
| The above-described rod-like liquid crystal compound (M-3) | 2 parts by mass |
| The above-described urethane monomer (EB1290 | 10 parts by mass |
| manufactured by DAICEL-ALLNEX LTD.) | |
| The above-described polymerization initiator | 4 parts by mass |
| (Irgacure OXE01, manufactured | |
| by BASF SE) | |
| The following fluorine-based polymer (M-6) | 3 parts by mass |
| The above-described fluorine-based | 0.3 parts by mass |
| polymer (M-4) | |
| The following onium salt compound S01 | 1.5 parts by mass |
| Toluene | 552 parts by mass |
| Methyl ethyl ketone (MEK) | 138 parts by mass |

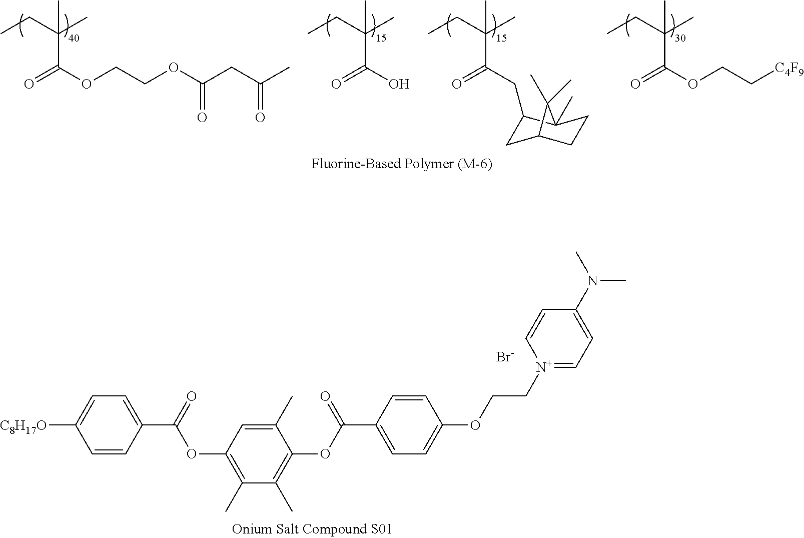

### Example 6

A polyethylene terephthalate (PET) film (“COSMO SHINE A4100” manufactured by TOYOBO CO., LTD.) whose one side was subjected to an easy adhesion treatment was prepared, and a side of the film opposite to the side subjected to the easy adhesion treatment was rubbed to provide a temporary substrate for transfer.

The following polymerizable liquid crystal composition 6 was applied to the rubbed surface of the above-described temporary substrate for transfer using a #5 wire bar, and an uncured liquid crystal composition layer was formed on the temporary substrate for transfer. Then, the liquid crystal composition layer was dried by heating at 100° C. for 3 minutes in a hot air dryer. Then, the dried liquid crystal composition layer was irradiated with ultraviolet rays with an integrated illuminance of 1,500 mJ/cm² to cure the liquid crystal composition layer, and thus a liquid crystal layer 6 was formed. The obtained liquid crystal layer 6 was red due to cholesteric alignment.

(Polymerizable Liquid Crystal Composition 6)

| | |
|---|---|
| The following liquid crystal compound (Z-1) | 85.1 parts by mass |
| The following compound (Z-2) | 5.3 parts by mass |
| Urethane acrylate | 3.3 parts by mass |
| (“Laromer LR9000”, manufactured by BASF SE) | |
| Polymerization Initiator (Irgacure 379, | 5.8 parts by mass |
| manufactured by BASF SE) | |
| Surfactant (S-420, manufactured by | 0.2 parts by mass |
| AGC SEIMI CHEMICAL CO., LTD.) | |
| Chiral agent (LC-756, manufactured by BASF SE) | 0.8 parts by mass |
| 1,3-Dioxolane | 51 parts by mass |
| Cyclopentanone | 34 parts by mass |

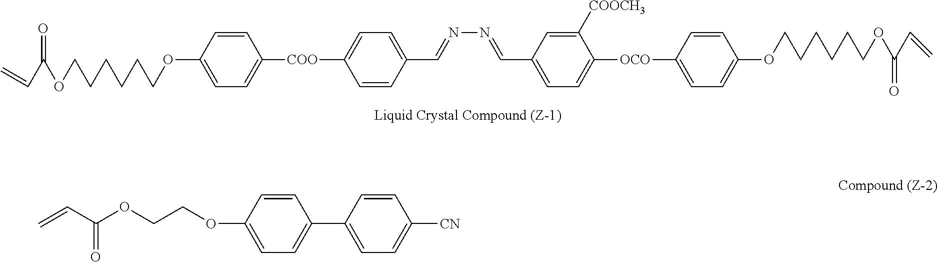

### Example 7

The following compositions were mixed and stirred at 80° C. for 1 hour to obtain a polymerizable liquid crystal composition 7. The polymerizable liquid crystal composition 7 was applied to the rubbed surface of the temporary substrate for transfer used in Example 6 using a bar coating method (#9, 30 mm/s). The applied film was left at a room temperature of 23° C. for 30 seconds, and then heated and dried in a drying zone at 120° C. for 1 minute to sufficiently remove the solvent and to cause phase transition of the polymerizable liquid crystal compound to an isotropic liquid crystal phase. Then, by gradual cooling up to the room temperature, the polymerizable liquid crystal compound underwent phase transition to a smectic liquid crystal state. Then, ultraviolet irradiation was performed from the coating film side with an exposure amount of 1,000 mJ/cm² (365 nm standard) using a UV irradiation device (SPOTCURE SP-7; manufactured by Ushio Inc.) to polymerize the polymerizable liquid crystal compound contained in the dried film while maintaining the smectic liquid crystal state of the polymerizable liquid crystal compound, whereby a liquid crystal layer 7 formed of the dried film was obtained. The obtained liquid crystal layer exhibited polarization selective absorptivity, and acted as a polarizer having a transmission axis in a direction parallel to the rubbing direction of the temporary substrate for transfer and having an absorption axis in a direction orthogonal to the transmission axis.

(Polymerizable Liquid Crystal Composition 7)

| | |
|---|---|
| The following liquid crystal compound (Z-3) | 75 parts by mass |
| The following compound (Z-4) | 25 parts by mass |
| The following dichroic dye 1 | 2.5 parts by mass |
| The following dichroic dye 2 | 2.5 parts by mass |
| The following dichroic dye 3 | 2.5 parts by mass |
| Polymerization initiator (Irgacure 369 | 6 parts by mass |
| (manufactured by BASF SE) | |
| Surfactant (BYK-361N, manufactured | 1.2 parts by mass |
| by BYK-Chemie GmbH) | |
| Toluene | 400 parts by mass |

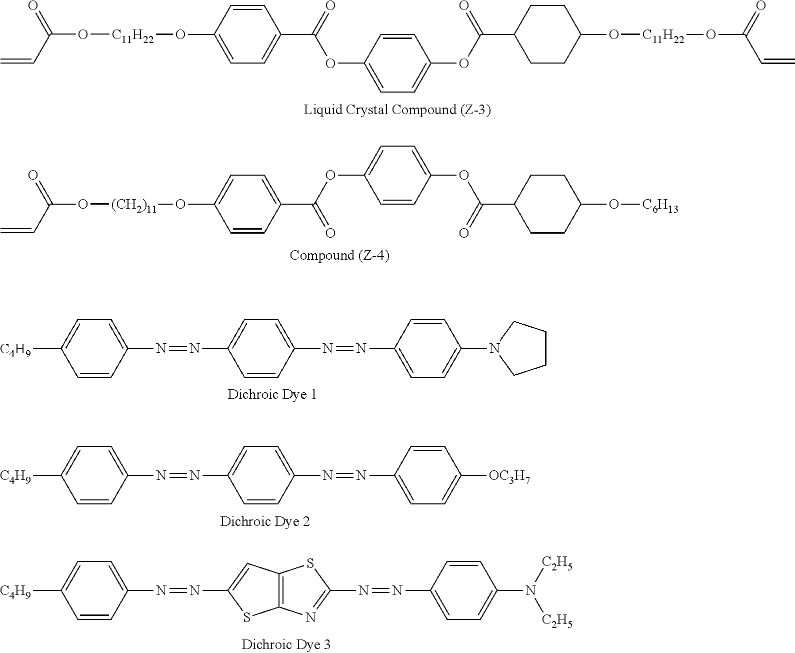

[Evaluation 2 of Liquid Crystal Film for Three-Dimensional Molding]

(Production of Substrate Film for Three-Dimensional Molding by Transfer of Liquid Crystal Layer)

Substrate films (“ZEONOR FILM ZF14-100” manufactured by Zeon Corporation, thickness: 100 μm) each formed of a resin containing an alicyclic structure-containing polymer were prepared as a substrate film for three-dimensional molding, and their one side were corona-treated.

Then, the following composition for forming an adhesive layer was applied to the corona-treated surfaces of the substrate films using a #2 wire bar, and a layer of the composition for forming an adhesive layer was formed as an uncured layer. Furthermore, the films manufactured in Examples 5 to 7 were respectively placed on the uncured layers so as to be in contact with the uncured layers on the liquid crystal layer side.

Then, lamination was performed using a pressing roll, and then ultraviolet rays from a high-pressure mercury lamp were applied from the substrate film side with an integrated illuminance of 800 mJ/cm². The triacetyl cellulose film or PET film as a temporary support was peeled off from the laminate (including the temporary support) in which the adhesive layer was formed, and liquid crystal films for three-dimensional molding (liquid crystal films 5 to 7 for three-dimensional molding) having a layer configuration of (liquid crystal layer/adhesive layer/substrate film) were thus obtained.

(Composition for Forming Adhesive Layer)

| | |
|---|---|
| 3,4-Epoxycyclohexylmethyl-3,4- | 40 parts by mass |
| epoxycyclohexanecarboxylate | |
| Bisphenol A diglycidyl ether | 60 parts by mass |
| Diphenyl(4-phenylthiophenyl)sulfonium | 4 parts by mass |
| hexafluoroantimonate (photocationic | |
| polymerization initiator) | |

(Evaluation 1)

The liquid crystal films for three-dimensional molding obtained in the above section (Production of Substrate Film for Three-Dimensional Molding by Transfer of Liquid Crystal Layer) were evaluated in terms of the rubbing haze variation and the coefficient of static friction described above.

In addition, a test sample was cut out from the laminate (including a temporary support) before peeling of the triacetyl cellulose film or PET film as the temporary support from the liquid crystal film for three-dimensional molding, and a peeling test was performed by performing a 90-degree peeling test on the film (substrate film) using a Tensilon universal material tester. The obtained initial peeling load peak value was defined as the breaking strength of the film (liquid crystal layer). The results thereof are shown in Table 2.

(Evaluation 2)

The liquid crystal films for three-dimensional molding produced in the above section (Production of Substrate Film for Three-Dimensional Molding by Transfer of Liquid Crystal Layer) were premolded in the same manner as in the above section (Appearance Evaluation, Extinction Evaluation, and Trimming Evaluation) to manufacture premolded bodies, and the appearance evaluation, the extinction evaluation, and the trimming evaluation were performed. The results are shown in Table 2.

However, the premolded body including the liquid crystal layer of Example 6 was irradiated with white light and observed in various directions to observe the reflection color hue of the cholesteric layer (showing an aspect in which in a case where the alignment state is maintained, a confronting point of the spherical crown is red, and the color gradually changes with an increasing distance from the confronting point). Those in which a predetermined change in color hue was maintained as a whole were evaluated as “A” in color hue, those in which an inconsistent color change was observed in less than 10% of the total area of the spherical crown were evaluated as “B” in color hue, and those in which an inconsistent color change was observed in 10% or greater of the total area of the spherical crown were evaluated as “C” in color hue. In addition, regarding the premolded body including the liquid crystal layer of Example 7, a white light source was placed inside the spherical crown, and the light leak observed through a polarizing plate placed to be in crossed Nicols with respect to the original transmission axis of the liquid crystal layer 7 was evaluated. Those in which a predetermined extinction position was maintained as a whole were evaluated as “A” in extinction, those in which light leak was observed in less than 10% of the total area of the spherical crown were evaluated as “B” in extinction, and those in which light leak was observed in 10% or greater of the total area of the spherical crown were evaluated as “C” in extinction.

(Evaluation 3)

From the liquid crystal films for three-dimensional molding obtained in the above section (Production of Substrate Film for Three-Dimensional Molding by Transfer of Liquid Crystal Layer), spherical crown-like plastic optical members were obtained in the same manner as in the above section (Evaluation of Three-Dimensional Molded Body). The appearances thereof were confirmed, and especially as for the three-dimensional molded body including the liquid crystal layer of Example 6, the color hue was confirmed in the same manner as in the section (Evaluation 2). The results are shown in Table 2.

TABLE 2

| | | | | | | | | Three-Dimensional | |
|---|---|---|---|---|---|---|---|---|---|
| | | Rubbing | | | Premolded Product | | | Molded Body | |
| | | Haze | Coefficient | Breaking | | Extinction | | | Extinction |
| | Liquid Crystal Film for | Variation | of Static | Load | | or Color | Trimming | | or Color |
| | Three-Dimensional Molding | (%) | Friction | (mN/cm) | Appearance | Hue | Property | Appearance | Hue |
| Example 5 | Liquid Crystal Film 5 for | 0.45 | 0.3 | 0.22 | A | A in | A | A | A in |
| | Three-Dimensional Molding | | | | | extinction | | | extinction |
| Example 6 | Liquid Crystal Film 6 for | 0.78 | 0.7 | 0.18 | A | A in color | A | A | B in color |
| | Three-Dimensional Molding | | | | | hue | | | hue |
| Example 7 | Liquid Crystal Film 7 for | 0.42 | 0.9 | 0.11 | A | A in | A | A | A in |
| | Three-Dimensional Molding | | | | | extinction | | | extinction |

[Evaluation of Image Reproducibility]

(Examples 8 to 11 and Comparative Examples 3 and 4) Spherical crown-like wire grid polarizers having a diameter of 70 mm and a depth of 10 mm were obtained in the way described in Example 1 in JP2013-200482A. The premolded bodies of Examples 1 to 4 and Comparative Examples 1 and 2 were respectively bonded to the projecting surface sides of the obtained spherical crown-like wire grid polarizers via a UV curable adhesive. The position adjustment was performed so that the angle between the direction of the transmission axis of the wire grid polarizer and the direction of the slow axes of the premolded bodies of Examples 1 to 4 and Comparative Examples 1 and 2 was 45°.

The obtained laminate and a separately prepared half mirror (transmittance: 50%) having a diameter of 70 mm, a depth of 10 mm, and a thickness of 60 μm were combined in the way shown in FIG. 2 (spherical crown-like wire grid polarizer 12, premolded body 14 of Example 1, 2, 3, or 4 or Comparative Example 1 or 2, half mirror 16, display surface 18), and lens elements of Examples 8 to 11 and Comparative Examples 3 and 4 were manufactured.

(Evaluation of Image Reproducibility)

A broadband λ/4 plate was bonded to a display surface of a liquid crystal panel with a polarizing plate detached from a smartphone (iPhone (registered trademark) 7, manufactured by Apple Inc.) so that the angle between the transmission axis of the polarizing plate on the visual side and the slow axis was 45°. The lens element produced as above was put on the display surface in a state in which black and white stripes having a width of 0.5 cm were displayed on the liquid crystal panel. A magnified image of the black and white stripes was observed through the lens element.

Regarding the magnified images of the black and white stripes observed on the center line (front) of the lens element and in a direction inclined by 10° to the center line of the lens element, the image reproducibility was evaluated as follows. The results are shown in Table 3.

A: The boundaries of the stripes maintained linearity, and a magnified image without distortion was obtained. In addition, it was not possible to visually recognize no decrease in contrast between black and white.

B: The boundaries of the stripes maintained linearity. No distortion was observed, but it was possible to visually recognize a decrease in contrast between black and white.

C: Distortion of the boundaries of the stripes was visually recognized, and the image reproducibility decreased.

### Example 12

A lens element was obtained in the same way as in Example 8, except that the above-described wire grid polarizer, the premolded body of Example 1, and the premolded body of Example 5 were superimposed in this order, and a three-layer configuration was thus obtained, and (Evaluation of Image Reproducibility) was performed as in Example 8. The obtained results of the evaluation of the lens element are shown in Table 3.

### Example 13

A lens element was obtained in the same way as in Example 8, except that the premolded body of Example 6 and the premolded body of Example 5 were superimposed in this order, and (Evaluation of Image Reproducibility) was performed as in Example 8. The obtained results of the evaluation of the lens element are shown in Table 3.

### Examples 14 and 15

The premolded body produced in Example 7 was laminated with an adhesive on the recessed surface side of each of the lens element produced in Example 8 and the lens element produced in Example 12. (Evaluation of Image Reproducibility) was performed in the same manner as in Example 8 on the obtained lens elements (Examples 14 and 15). The obtained results of the evaluation of the lens element are shown in Table 3.

TABLE 3

| | Laminate | | Image Reproducibility | |
|---|---|---|---|---|
| | ←Recessed Surface Side | Projecting Surface Side→ | Front | Inclined |
| Example 8 | Wire Grid Polarizer | Premolded Body of Example 1 | A | B |
| Example 9 | Wire Grid Polarizer | Premolded Body of Example 2 | A | B |
| Example 10 | Wire Grid Polarizer | Premolded Body of Example 3 | B | B |
| Example 11 | Wire Grid Polarizer | Premolded Body of Example 4 | A | B |

| | | | | | |
|---|---|---|---|---|---|
| Example 12 | Wire Grid Polarizer | Premolded Body of Example 1 | Premolded Body of Example 5 | A | A |

| | | | | |
|---|---|---|---|---|
| Example 13 | Premolded Body of Example 6 | Premolded Body of Example 5 | B | B |
| Example 14 | Premolded Body of Example 7 | Premolded Body of Example 8 | A | A |
| Example 15 | Premolded Body of Example 7 | Premolded Body of Example 12 | A | A |
| Comparative | Wire Grid Polarizer | Premolded Body of Comparative Example 1 | C | C |
| Example 3 | | | | |
| Comparative | Wire Grid Polarizer | Premolded Body of Comparative Example 2 | C | C |
| Example 4 | | | | |

As shown in the table, it was confirmed that the liquid crystal film for three-dimensional molding according to the embodiment of the present invention exhibits a desired effect (excellent reproducibility of image light during image light irradiation).

From the comparison between Examples 8 to 11, it was confirmed that in a case where the rubbing haze variation is 0.70% or less (Examples 8, 9, and 11), the effect is further improved. From the comparison between Examples 12 to 15, it was also confirmed that in a case where the rubbing haze variation is 0.70% or less, the effect is further improved.

In addition, it was confirmed that the image reproducibility in the column “inclined” is further improved in Example 12 in which the liquid crystal layer 5 as a C-plate is further provided, and in Examples 14 and 15 in which the liquid crystal layer 7 functioning as an absorption type polarizer is further provided.

### EXPLANATION OF REFERENCES

1: substrate
2: functional layer
10: liquid crystal film for three-dimensional molding
12: wire grid polarizer
14: premolded body
16: half mirror
18: display surface

What is claimed is:

1. A liquid crystal film for three-dimensional molding comprising:
a substrate; and
a functional layer,
wherein the functional layer includes a liquid crystal layer, and the liquid crystal layer is made from a liquid crystal composition, and
a rubbing haze variation of an outermost surface of the functional layer is 0.8% or less.

2. The liquid crystal film for three-dimensional molding according to claim 1,
wherein a coefficient of static friction of the outermost surface of the functional layer is less than 1.0.

3. The liquid crystal film for three-dimensional molding according to claim 1,
wherein a breaking load of the functional layer is 0.10 mN/cm or greater.

4. The liquid crystal film for three-dimensional molding according to claim 1,
wherein the liquid crystal layer is placed on an outermost surface side of the functional layer.

5. The liquid crystal film for three-dimensional molding according to claim 1,
wherein the liquid crystal composition is a polymerizable liquid crystal composition.

6. The liquid crystal film for three-dimensional molding according to claim 5,
wherein the polymerizable liquid crystal composition contains a polyfunctional polymerizable liquid crystal compound.

7. The liquid crystal film for three-dimensional molding according to claim 5,
wherein the polymerizable liquid crystal composition contains a non-liquid crystalline polyfunctional polymerizable compound.

8. The liquid crystal film for three-dimensional molding according to claim 7,
wherein the non-liquid crystalline polyfunctional polymerizable compound is an ester compound of a urethane polyol and a (meth)acrylic acid, or an ester compound of an ester polyol and a (meth)acrylic acid.

9. The liquid crystal film for three-dimensional molding according to claim 1,
wherein the liquid crystal composition contains a polymerizable liquid crystal compound, and
the polymerizable liquid crystal compound exhibits a smectic phase.

10. A three-dimensional molded body comprising:
the liquid crystal film for three-dimensional molding according to claim 1; and
a resin base,
wherein the liquid crystal film for three-dimensional molding and the resin base are molded integrally with each other.

11. A method of manufacturing a three-dimensional molded body, comprising:
a step 1 of premolding the liquid crystal film for three-dimensional molding according to claim 1 through a vacuum molding step;
a step 2 of inserting the premolded liquid crystal film for three-dimensional molding in a predetermined position in an injection mold, and closing the mold; and
a step 3 of injecting a fluidized resin into a cavity formed by closing the injection mold to form a three-dimensional molded body in which the resin and the liquid crystal film for three-dimensional molding are integrated with each other.

12. The method of manufacturing a three-dimensional molded body according to claim 11, further comprising:
a step 4 of trimming an extra portion of the premolded liquid crystal film for three-dimensional molding between the steps 1 and 2.

13. A method of manufacturing a three-dimensional molded body comprising:
a step of vacuum-molding the liquid crystal film for three-dimensional molding according to claim 1 to obtain a three-dimensional molded body.

14. A three-dimensional molded body which is molded using the liquid crystal film for three-dimensional molding according to claim 1.

15. The liquid crystal film for three-dimensional molding according to claim 2,
wherein a breaking load of the functional layer is 0.10 mN/cm or greater.

16. The liquid crystal film for three-dimensional molding according to claim 2,
wherein the liquid crystal layer is placed on an outermost surface side of the functional layer.

17. The liquid crystal film for three-dimensional molding according to claim 2,
wherein the liquid crystal composition is a polymerizable liquid crystal composition.

18. The liquid crystal film for three-dimensional molding according to claim 17,
wherein the polymerizable liquid crystal composition contains a polyfunctional polymerizable liquid crystal compound.

19. The liquid crystal film for three-dimensional molding according to claim 17,
wherein the polymerizable liquid crystal composition contains a non-liquid crystalline polyfunctional polymerizable compound.

20. The liquid crystal film for three-dimensional molding according to claim 19,
wherein the non-liquid crystalline polyfunctional polymerizable compound is an ester compound of a urethane polyol and a (meth)acrylic acid, or an ester compound of an ester polyol and a (meth)acrylic acid.
